(19) United States
(12) Patent Application Publication
(10) Pub. No.: US 2026/0131732 A1
(43) Pub. Date: May 14, 2026

(54) IN-VEHICLE DEVICE THAT DISPLAYS VIDEO IMAGES

(71) Applicant: Panasonic Automotive Systems Co., Ltd., Kanagawa (JP)

(72) Inventors: Ryohei YOSHIDA, Kanagawa (JP); Manabu OSHIMA, Gunma (JP); Tetsuaki MURAYAMA, Tokyo (JP); Takenori KANEKO, Kanagawa (JP); Kenta SUZUKI, Kanagawa (JP)

(73) Assignee: Panasonic Automotive Systems Co., Ltd., Kanagawa (JP)

(21) Appl. No.: 19/384,879

(22) Filed: Nov. 10, 2025

(30) Foreign Application Priority Data
Nov. 11, 2024 (JP) 2024-196656

(51) Int. Cl. B60R 1/26

(52) U.S. Cl. CPC B60R 1/26; B60R 2300/207; B60R 2300/70; B60R 2300/802

(57) ABSTRACT

When switching display of a monitor from a first or second video image to a third video image, a processor displays the first or second video image delayed by a frame memory on the monitor, then displays a dummy image on the monitor, and then displays the third video image not delayed by the frame memory on the monitor. When switching display of the monitor from the first video image to the second video image, the processor displays the first video image delayed by the frame memory on the monitor and then displays the second video image delayed by the frame memory on the monitor without displaying the dummy image on the monitor.

### BACKGROUND

### 1. Technical Field

The present disclosure relates to an in-vehicle device and particularly to an in-vehicle device that displays video images.

### 2. Description of the Related Art

In order to assist the driving operation at the time of reversing, a camera is installed at the rear of a vehicle, and a video image of an area in the reverse direction is displayed and output in a visible manner. This video image may be processed to reduce distortion and make it easier to see (see Patent Document 1, for example).

[Patent Document 1] Japanese Patent Application Publication No. 2014-191690

The video image of the area in the reverse direction is displayed on the monitor of an in-vehicle device, for example. This monitor of an in-vehicle device displays multiple types of video images, not just a video image in the reverse direction. Even if the standards for each of the multiple types of video images are different, the standards are required to be satisfied.

### SUMMARY

The present invention has been made in view of such a situation, and a general purpose thereof is to provide a technology for displaying multiple types of video images with different standards.

An in-vehicle device according to one embodiment of the present disclosure relates to an in-vehicle device that is mountable in a vehicle, including: a generator that generates a first video image; and a processor that receives the first video image from the generator and displays the delayed first video image on a monitor after delaying the first video image by a frame memory. The processor receives the second video image from an imaging device outside the in-vehicle device and displays the second video image on the monitor after delaying the second video image by the frame memory. The generator receives a third video image from a communication device outside the in-vehicle device. The processor receives the third video image from the generator and displays the third video image on the monitor without delaying the third video image by the frame memory. When switching display of the monitor from the first or second video image to the third video image, the processor displays the first or second video image delayed by the frame memory on the monitor, then displays a dummy image on the monitor, and then displays the third video image not delayed by the frame memory on the monitor. When switching display of the monitor from the third video image to the first or second video image, the processor displays the third video image not delayed by the frame memory on the monitor, then displays the dummy image on the monitor, and then displays the first or second video image delayed by the frame memory on the monitor. When switching display of the monitor from the first video image to the second video image, the processor displays the first video image delayed by the frame memory on the monitor and then displays the second video image delayed by the frame memory on the monitor without displaying the dummy image on the monitor. When switching display of the monitor from the second video image to the first video image, the processor displays the second video image delayed by the frame memory on the monitor and then displays the first video image delayed by the frame memory on the monitor without displaying the dummy image on the monitor.

Optional combinations of the aforementioned constituting elements and implementations of the present disclosure in the form of methods, apparatuses, systems, recording mediums, and computer programs may also be practiced as additional modes of the present disclosure.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a diagram showing the configuration of a vehicle according to an embodiment;

FIGS. 2A-2D are diagrams showing the outline of processing timing of video images in an in-vehicle device according to FIG. 1;

FIG. 3 is a diagram showing the outline of a process performed when switching a video image to be output in the in-vehicle device according to FIG. 1; and

FIG. 4 is a flowchart showing the output procedure for a video image by the in-vehicle device according to FIG. 1.

### DETAILED DESCRIPTION

The invention will now be described by reference to the preferred embodiments. This does not intend to limit the scope of the present invention, but to exemplify the invention.

A brief description of the present disclosure will be given before a specific description thereof is given. An embodiment of the present disclosure relates to an in-vehicle device that is mounted on a vehicle and is capable of displaying multiple types of video images on a monitor. An example of the in-vehicle device is display audio equipment. One of the video images displayed on the monitor of the in-vehicle device is an video image generated by a system on a chip (SoC) inside the in-vehicle device (hereinafter referred to as the “first video image”). An example of the first video image is a menu screen. The first video image generated by the SoC is input to an image processing large scale integration (LSI), and the image processing LSI displays the first video image on the monitor. Further, another one of the video images displayed on the monitor of the in-vehicle device isa video image captured by an imaging device mounted on the vehicle (hereinafter referred to as “second video image”). An example of the second video image is a video image of an area in the reversing direction of the vehicle. In this case, the imaging device is mounted at the rear of the vehicle. Since such a second video image is required to be displayed on the monitor in a short period of time after the imaging device is activated (hereinafter also referred to as “high-speed activation”), the second video image is directly captured into the image processing LSI without going through the SoC.

In the in-vehicle device, it is required to switch between the first and second video images. Since the first and second video images are generated by different devices, a synchronization signal at the time of generating the first video image and a synchronization signal at the time of generating the second video image are different in timing. Therefore, switching these images immediately causes video image disturbance and thus lowers the image quality due to the difference in the timing of the synchronization signals. If a dummy image such as a black image is displayed on the monitor at the time of switching in order to suppress video image disturbance, the requirement for high-speed activation for the second video image cannot be met. Therefore, the image processing LSI has a built-in frame memory and uses the frame memory to match the timing for the synchronization signals between the two images so as to achieve seamless switching without video disturbance.

Still another one of the video images displayed on the monitor of the in-vehicle device is a video image generated by a communication device with which the in-vehicle device communicates (hereinafter referred to as “third video image”). An example of the communication device is a smartphone. When the user enters an instruction for the display of the third video image into the in-vehicle device, the in-vehicle device transmits the instruction to the communication device, the third video image according to the instruction is then transmitted from the communication device to the in-vehicle device, and the in-vehicle device displays the third video image on the monitor. For such a third video image, the standard requires delay time from when the in-vehicle device receives an instruction for the display of the third video image until when the in-vehicle device displays the third video image on the monitor to be shorter than a threshold value.

When the abo-described frame memory is used, the delay increases due to data buffering. Therefore, if the frame memory is used to display the third video image, the standard can no longer be met. The in-vehicle device according to the present embodiment uses a frame memory for the first and second video images to demonstrate seamless switching but satisfies the standard without using a frame memory for the third video image. Therefore, at the time of switching with the third video image, a black image is output to suppress image disturbance. Hereinafter, the first, second, and third video images are collectively referred to as “video images.”

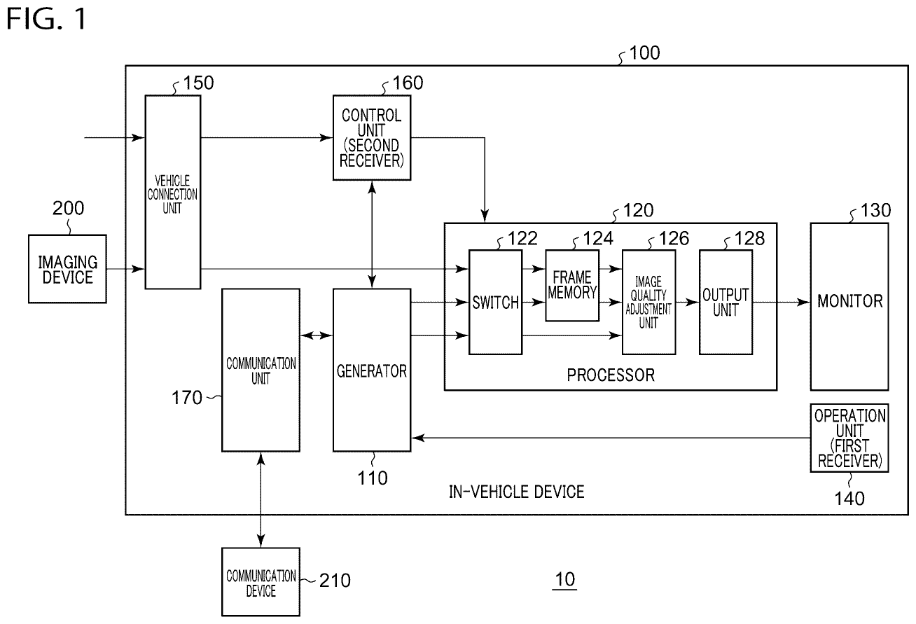

FIG. 1 shows the configuration of a vehicle 10. The vehicle 10 is equipped with an in-vehicle device 100 and an imaging device 200. The in-vehicle device 100 includes a generator 110, a processor 120, a monitor 130, an operation unit 140, a vehicle connection unit 150, a control unit 160, and a communication unit 170. The processor 120 includes a switch 122, a frame memory 124, an image quality adjustment unit 126, and an output unit 128. A communication device 210 is connected to the vehicle 10.

The operation unit 140 is an interface that can be operated by the user. The operation unit 140 is integrated with the monitor 130 as a touch panel. Further, the operation unit 140 may be a button or the like. The operation unit 140 receives a display instruction for the first video image or the third video image from the user. The operation unit 140 outputs the received instruction to the generator 110.

The vehicle connection unit 150 is an interface capable of performing communication by a controller area network (CAN), etc., for example. The vehicle connection unit 150 is capable of communicating with the vehicle controller (not shown) mounted on the vehicle 10 and receives a vehicle signal indicating a predetermined traveling state of the vehicle 10 from the vehicle controller. In the present embodiment, the focus is on whether the vehicle 10 is reversing or not as the predetermined traveling state indicated by a vehicle signal. The vehicle connection unit 150 outputs a vehicle signal to the control unit 160.

The control unit 160 controls the operation of the generator 110 and the processor 120 according to the vehicle signal. The control unit 160 gives an operation instruction to the generator 110 and the processor 120 when the vehicle signal does not indicate the reversing of the vehicle 10. On the other hand, the control unit 160 instructs the generator 110 to stop when the vehicle signal indicates the reversing of the vehicle 10 and also gives a reversing operation instruction to the processor 120. If the operation unit 140 is to be defined as “first receiver,” the vehicle connection unit 150 or the control unit 160 may be defined as “second receiver.”

The generator 110 corresponds to the SoC mentioned above. The generator 110 generates the first video image when receiving a display instruction for the first video image from the operation unit 140 and an operation instruction from the control unit 160. The first video image is, for example, a menu screen. A known technology needs to be used to generate the first video image in the generator 110, and the explanation thereof is thus omitted. The generator 110 outputs the first video image to the processor 120. At that time, identification information for identifying the first or third video image is also output to the processor 120.

The processor 120 corresponds to the above-described image processing LSI. The switch 122 of the processor 120 receives the first video image from the generator 110. Further, the switch 122 receives an operation instruction from the control unit 160 and also receives the identification information of the first video image from the generator 110. In that case, the switch 122 outputs the first video image to the frame memory 124. The frame memory 124 is a video buffer that delays the first video image and then outputs the first video image to the image quality adjustment unit 126. The image quality adjustment unit 126 performs processes such as combining two video images, enlarging and reducing video images, etc. Known techniques need to be used for these processes, and the explanation thereof is thus omitted here. The output unit 128 displays the first video image from the image quality adjustment unit 126 on the monitor 130.

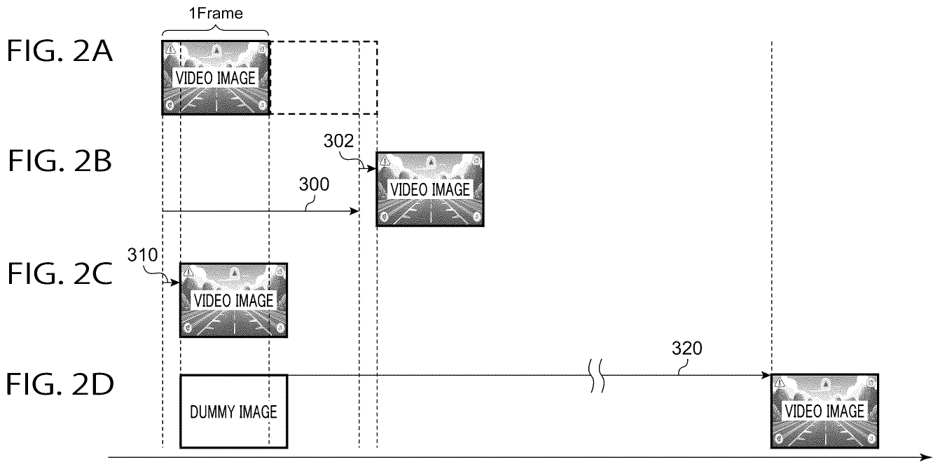

FIGS. 2A to 2D show the outline of processing timing of video images in the in-vehicle device 100. In these figures, the horizontal axis indicates time. FIG. 2A shows the first video image that is input to the processor 120. FIG. 2B shows the first video image that is output from the processor 120 via the frame memory 124. With reference to the input timing in FIG. 2A, the first video image is output with a delay of the combined period of a frame memory delay 300 due to the delay in the frame memory 124 and a processing delay 302 required for the process in the processor 120. The frame memory delay 300 and the processing delay 302, when combined, are shorter than two frames, for example. FIGS. 2C to 2D will be described later, and the description now returns to FIG. 1.

The imaging device 200 is mounted on the vehicle 10. The imaging device 200 captures a video image of an area in the reverse direction of the vehicle 10 as the second video image, for example. The imaging device 200 is capable of communicating with the in-vehicle device 100 by means of, for example, CAN, etc. The imaging device 200 transmits the second video image to the in-vehicle device 100. The vehicle connection unit 150 receives the second video image from the imaging device 200. The vehicle connection unit 150 outputs the second video image to the processor 120.

The switch 122 of the processor 120 receives the second video image from the vehicle connection unit 150. Further, the switch 122 receives a reversing operation instruction from the control unit 160. In that case, the switch 122 outputs the second video image to the frame memory 124. The frame memory 124 delays the second video image and then outputs the second video image to the image quality adjustment unit 126. The output unit 128 displays the second video image from the image quality adjustment unit 126 on the monitor 130.

FIG. 2A shows the second video image that is input to the processor 220. FIG. 2B shows the second video image that is output from the processor 120 via the frame memory 124. As in the first video image, the second video image is output with a delay of the combined period of the frame memory delay 300 and the processing delay 302 wire reference to the input timing in FIG. 2A. The frame memory delay 300 and the processing delay 302, when combined, are shorter than two frames, for example. FIGS. 2C to 2D will be described later, and the description now returns to FIG. 1.

The operation unit 140 may receive an instruction to change the third video image from the user in addition to a display instruction for the third video image. In the following, the instruction to change the third video image is also included in the display instruction for the third video image. When receiving a display instruction for the third video image from the operation unit 140 and an operation instruction from the control unit 160, the generator 110 outputs a display instruction for the third video image. The communication unit 170 complies with a wireless local area network (LAN) and a short-range wireless communication system and is capable of performing wireless communication. The communication unit 170 transmits instructions to the communication device 210 by wireless communication.

The communication device 210 exists outside the in-vehicle device 100. The communication device 210 is, for example, a smartphone or a tablet terminal. The communication device 210 is capable of performing wireless communication with the communication unit 170. The communication device 210 receives an instruction from the communication unit 170. The communication device 210 generates the third video image according to the instruction received. The third video image may be generated by the communication device 210 alone or may be generated in a server (not shown) with which the communication device 210 communicates. The communication device 210 transmits the third video image to the vehicle 10.

The communication unit 170 of the vehicle 10 receives the third video image from the communication device 210. The communication unit 170 outputs the third video image to the generator 110, and the generator 110 outputs the third video image to the processor 120. At that time, identification information for identifying the third video image is also output to the processor 120. The switch 122 of the processor 120 receives the third video image from the generator 110. Further, the switch 122 receives an operation instruction from the control unit 160 and also receives the identification information of the third video image from the generator 110. In that case, the switch 122 outputs the third video image to the image quality adjustment unit 126. The output unit 128 displays the third video image from the image quality adjustment unit 126 on the monitor 130. In other words, the processor 120 receives the third video image from the generator 110 and displays the third video image on the monitor 130 without delay in the frame memory 124.

FIG. 2A shows the third video image that is input to the processor 120. FIG. 2C shows the third video image that is output from the processor 120 via the frame memory 124. With reference to the input timing in FIG. 2A, the third video image is output with a delay of a processing delay 310 required for the process in the processor 120. The processing delay 310 is, for example, shorter than one frame and less than one msec. For such a third video image, it is specified that delay time from when an instruction for the third video image is received until when the third video image according to the instruction is displayed on the monitor 130 is specified to be shorter than a threshold value (hereinafter referred to as “first threshold value”). On the other hand, for a first video image, delay time from when an instruction for the first video image is received until when the first video image according to the instruction is displayed on the monitor 330 is specified to be shorter than a threshold value (hereinafter referred to as “second threshold value”). The second threshold value is set to be longer than the first threshold value. Alternatively, the first video image does not need to have a requirement for the delay time from when an instruction for the first video image is received until when the first video image according to the instruction is displayed on the monitor 130. FIG. 2D will be described later, and the description now returns to FIG. 1.

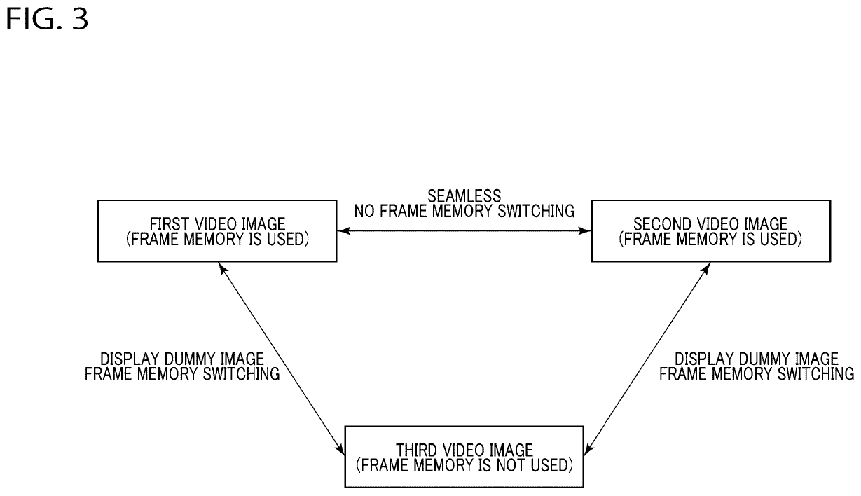

The process of displaying the first, second, and third video images alone has been explained thus far. In the following, a process of switching the display between the first, second, and third video images will be explained. FIG. 3 shows the outline of a process performed when switching a video image to be output in the in-vehicle device 100. As described above, video images displayed on the monitor 130 of the in-vehicle device 100 are the first, second, and third video images, and switching is therefore performed between these video images. An explanation will be given here in the following order: (1) switching from the first video image to the second video image, (2) switching from the second video image to the first video image, (3) switching from the first video image to the third video image, (4) switching from the third video image to the first video image, (5) switching from the second video image to the third video image, and (6) switching from the third video image to the second video image.

### (1) Switching From First Video Image to Second Video Image

In this case, a state (hereinafter referred to as “pre-state”) is implemented where the generator 110 is receiving a display instruction for the first video image from the operation unit 140 and an operation instruction from the control unit 160 and where the switch 122 is receiving an operation instruction from the control unit 160 and an identification information of the first video image from the generator 110. At that time, the processor 120 receives the first video image. Further, from the pre-state, switching to a state (hereinafter referred to as “post-state”) where the switch 122 receives a reversing operation instruction from the control unit 160 is performed. At that time, the processor 120 receives the second video image.

In the pre-state, the processor 120 displays the first video image delayed by the frame memory 124 on the monitor 130. Upon switching to the post-state, the processor 120 displays the second video image delayed by the frame memory 124 on the monitor 130. In other words, upon switching from the pre-state to the post state, the processor 120 simply switches the input to the frame memory 124 from the first video image to the second video image; thus, the switching from the first video image to the second video image is made seamlessly without switching whether or not to use the frame memory 124. Therefore, the processor 120 does not display a dummy image on the monitor 130 at the time of the switching.

### (2) Switching From Second Video Image to First Video Image

In this case, a state (hereinafter referred to as “pre-state”) is implemented where the switch 122 receives a reversing operation instruction from the control unit 160 is executed. At that time, the processor 120 receives the second video image. Further, from the pre-state, a switch is made to a state (hereinafter referred to as “post-state”) where the generator 110 is receiving a display instruction for the first video image from the operation unit 140 and an operation instruction from the control unit 160 and where the switch 122 is receiving an operation instruction from the control unit 160 and an identification information of the first video image from the generator 110. At that time, the processor 120 receives the first video image.

In the pre-state, the processor 120 displays the second video image delayed by the frame memory 124 on the monitor 130. Upon switching to the post-state, the processor 120 displays the first video image delayed by the frame memory 124 on the monitor 130. In other words, upon switching from the pre-state to the post-state, the processor 120 simply switches the input to the frame memory 124 from the second video image to the first video image; thus, the switching from the second video image to the first video image is made seamlessly without switching whether or not to use the frame memory 124. Therefore, the processor 120 does not display a dummy image on the monitor 130 at the time of the switching.

### (3) Switching From First Video Image to Third Video Image

In this case, a state (hereinafter referred to as “pre-state”) is implemented where the generator 110 is receiving a display instruction for the first video image from the operation unit 140 and an operation instruction from the control unit 160 and where the switch 122 is receiving an operation instruction from the control unit 160 and an identification information of the first video image from the generator 110. At that time, the processor 120 receives the first video image. Further, from the pre-state, a switch is made to a state (hereinafter referred to as “post-state”) where the generator 110 is receiving a display instruction for the third video image from the operation unit 140 and an operation instruction from the control unit 160 and where the switch 122 is receiving an operation instruction from the control unit 160 and an identification information of the third video image from the generator 110. At that time, the processor 120 receives the third video image.

In the pre-state, the processor 120 displays the first video image delayed by the frame memory 124 on the monitor 130. Upon switching to the post-state, the processor 120 displays a dummy image on the monitor 130 and then displays the third video image that has not been delayed by the frame memory 124 on the monitor 130. In other words, upon switching from the pre-state to the post-state, the processor 120 changes from the state of inputting the first video image to the frame memory 124 to inputting the third video image to the image quality adjustment unit 126 without using the frame memory 124. When switching from the first video image to the third video image, whether or not to use the frame memory 124 is switched. It is necessary to match the timing for the synchronization signals when switching whether or not to use the frame memory 124. A dummy image is displayed on the monitor 130 while the timing for the synchronization signal is being matched.

FIG. 2A shows the third video image that is input to the processor 120. This third video image is to be switched from the first video image and displayed. FIG. 2D shows the third video image that is output from the processor 120 via the frame memory 124. After the output from the processor 120 of the first video image before the switching is ended and the third video image after the switching is then input to the processor 120, a dummy image is output while the timing for the synchronization signals thereof is being matched (switching delay 320). The third video image is output after the end of the switching delay 320. The switching delay 320 is set to be shorter than, for example, six frames.

### (4) Switching From Third Video Image to First Video Image

In this case, a state (hereinafter referred to as “pre-state”) is implemented where the generator 110 is receiving a display instruction for the third video image from the operation unit 140 and an operation instruction from the control unit 160 and where the switch 122 is receiving an operation instruction from the control unit 160 and an identification information of the third video image from the generator 110. At that time, the processor 120 receives the third video image. Further, from the pre-state, a switch is made to a state (hereinafter referred to as “post-state”) where the generator 110 is receiving a display instruction for the first video image from the operation unit 140 and an operation instruction from the control unit 160 and where the switch 122 is receiving an operation instruction from the control unit 160 and an identification information of the first video image from the generator 110. At that time, the processor 120 receives the first video image.

In the pre-state, the processor 120 displays the third video image not delayed by the frame memory 124 on the monitor 130. Upon switching to the post-state, the processor 120 displays a dummy image on the monitor 130 and then displays the first video image that has been delayed by the frame memory 124 on the monitor 130. In other words, upon switching from the pre-state to the post-state, the processor 120 changes from the state of inputting the third video image to the image quality adjustment unit 126 without using the frame memory 124 to inputting the first video image to the frame memory 124. When switching from the third video image to the first video image, whether or not to use the frame memory 124 is switched. It is necessary to match the timing for the synchronization signals when switching whether or not to use the frame memory 124. A dummy image is displayed on the monitor 130 while the timing for the synchronization signal is being matched.

FIG. 2A shows the first video image that is input to the processor 120. This first video image is to be switched from the third video image and displayed. FIG. 2D shows the first video image that is output from the processor 120 via the frame memory 124. After the output from the processor 120 of the third video image before the switching is ended and the first video image after the switching is then input to the processor 120, a dummy image is output for the switching delay 320. The first video image is output after the end of the switching delay 320.

### (5) Switching From Second Video Image to Third Video Image

In this case, a state (hereinafter referred to as “pre-state”) is implemented where the switch 122 receives a reversing operation instruction from the control unit 160 is executed. At that time, the processor 120 receives the second video image. Further, from the pre-state, a switch is made to a state (hereinafter referred to as “post-state”) where the generator 110 is receiving a display instruction for the third video image from the operation unit 140 and an operation instruction from the control unit 160 and where the switch 122 is receiving an operation instruction from the control unit 160 and an identification information of the third video image from the generator 110. At that time, the processor 120 receives the third video image.

In the pre-state, the processor 120 displays the second video image delayed by the frame memory 124 on the monitor 130. Upon switching to the post-state, the processor 120 displays a dummy image on the monitor 130 and then displays the third video image that has not been delayed by the frame memory 124 on the monitor 130. In other words, upon switching from the pre-state to the post-state, the processor 120 changes from the state of inputting the second video image to the frame memory 124 to inputting the third video image to the image quality adjustment unit 126 without using the frame memory 124. When switching from the second video image to the third video image, whether or not to use the frame memory 224 is switched. It is necessary to match the timing for the synchronization signals when switching whether or not to use the frame memory 124. A dummy image is displayed on the monitor 130 while the timing for the synchronization signal is being matched.

### (6) Switching From Third Video Image to Second Video Image

In this case, a state (hereinafter referred to as “pre-state”) is implemented where the generator 110 is receiving a display instruction for the third video image from the operation unit 140 and an operation instruction from the control unit 160 and where the switch 122 is receiving an operation instruction from the control unit 160 and an identification information of the third video image from the generator 110. At that time, the processor 120 receives the third video image. Further, from the pre-state, switching to a state (hereinafter referred to as “post-state”) where the switch 122 receives a reversing operation instruction from the control unit 160 is made. At that time, the processor 120 receives the second video image.

In the pre-state, the processor 120 displays the third video image not delayed by the frame memory 124 on the monitor 130. Upon switching to the post-state, the processor 120 displays a dummy image on the monitor 130 and then displays the second video image that has been delayed by the frame memory 124 on the monitor 130. In other words, upon switching from the pre-state to the post-state, the processor 120 changes from the state of inputting the third video image to the image quality adjustment unit 126 without using the frame memory 124 to inputting the second video image to the frame memory 124. When switching from the third video image to the second video image, whether or not to use the frame memory 124 is switched. It is necessary to match the timing for the synchronization signals when switching whether or not to use the frame memory 124. A dummy image is displayed on the monitor 130 while the timing for the synchronization signal is being matched.

The configuration is implemented in hardware by any central processing unit (CPU) of a computer, memory or other large scale integration (LSI), and in software by a program or the like loaded into the memory. The figure depicts functional blocks implemented by the cooperation of hardware and software. Thus, a person skilled in the art should appreciate that there are many ways of accomplishing these functional blocks in various forms in accordance with the components of hardware only or the combination of hardware and software.

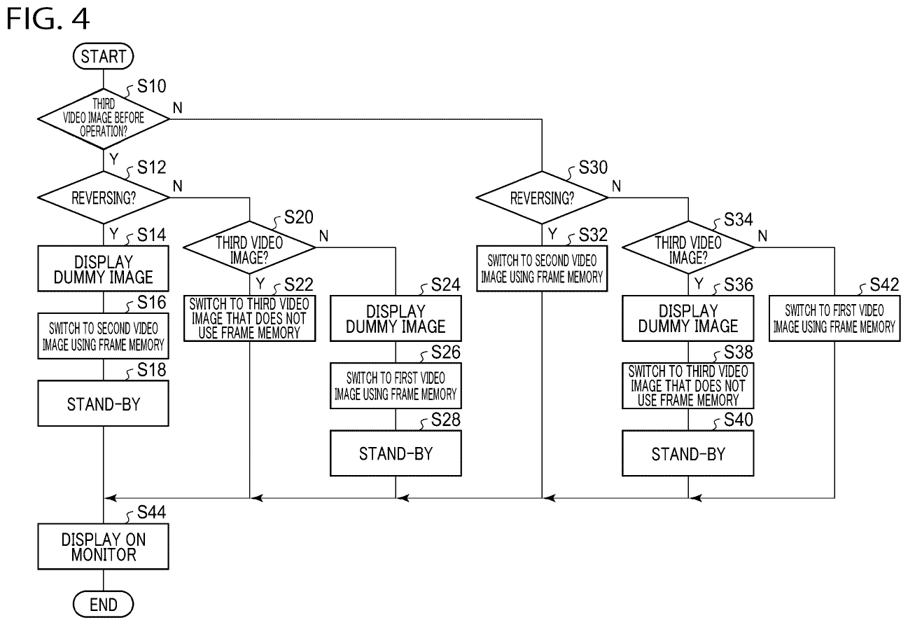

A description will be given of the operation of the in-vehicle device 100 configured as described above. FIG. 4 is a flowchart showing the output procedure for a video image by the in-vehicle device 100. When the output of the third video image is set before the operation (Y at S10), the processor 120 displays a dummy image on the monitor 130 (S14) if the processor 120 receives a vehicle signal indicating reversing (Y at S12). The processor 120 uses the frame memory 124 to switch to the second video image (S16). Then, the processor 120 is on stand-by during the switching delay 320 (S18). When receiving a display instruction for the third video image (Y at S20) without receiving a vehicle signal indicating reversing (N at S12), the processor 120 switches to the third video image that does not use the frame memory 124 (S22). When a display instruction for the third video image is not being received (N at S20), the processor 120 displays a dummy image on the monitor 130 (S24). The processor 120 uses the frame memory 124 to switch to the first video image (S26). Then, the processor 120 is on stand-by during the switching delay 320 (S28).

When the output of the third video image is not set before the operation (N at S10), the processor 120 uses the frame memory 124 to switch to the second video image (S32) if the processor 120 receives a vehicle signal indicating reversing (Y at S30). When receiving a display instruction for the third video image (Y at S34) without receiving a vehicle signal indicating reversing (N at S30), the processor 120 displays a dummy image on the monitor 130 (S36). The processor 120 switches to the third video image, which does not use the frame memory 124 (S38). Then, the processor 120 is on stand-by during the switching delay 320 (S40). When a display instruction for the third video image is not being received (N at S34), the processor 120 uses the frame memory 124 to switch to the first video image (S42). The processor 120 displays one of the first to third video images on the monitor 130 (S44).

According to the present embodiment, the frame memory 124 is used for the first and second video images, and the frame memory 124 is not used for the third video image; thus, seamless switching between the first and second video images and shortening of the delay for the third video image can be realized. In addition, since seamless switching between the first and second video images and shortening of the delay for the third video image are realized, multiple types of video images with different standards can be displayed. Further, since the first video image is switched to the second video image seamlessly, the requirement for the high-speed activation of the second video image can be satisfied. In addition, since the shortening of the delay for the third video image is realized, the standard for the third video image can be satisfied.

Further, since switching between the display of the first video image and the display of the third video image is made based on the display instruction for the first or third video image received from the user and switching whether to display the second video image is made based on a vehicle signal, the display of multiple types of video images can be switched. Further, the second video image can be displayed when the vehicle is in a reversing state.

The outline of one aspect of the present disclosure is as follows.

### Item 1

An in-vehicle device that is mountable in a vehicle, including:
a generator that generates a first video image; and
a processor that receives the first video image from the generator and displays the delayed first video image on a monitor after delaying the first video image by a frame memory,
wherein the processor receives the second video image from an imaging device outside the in-vehicle device and displays the second video image on the monitor after delaying the second video image by the frame memory,
wherein the negation unit receives a third video image from a communication device outside the in-vehicle device,
wherein the processor receives the third video image from the generator and displays the third video image on the monitor without delaying the third video image by the frame memory,
wherein when switching display of the monitor from the first or second video image to the third video image, the processor displays the first or second video image delayed by the frame memory on the monitor, then displays a dummy image on the monitor, and then displays the third video image not delayed by the frame memory on the monitor,
wherein when switching display of the monitor from the third video image to the first or second video image, the processor displays the third video image not delayed by the frame memory on the monitor, then displays the dummy image on the monitor, and then displays the first or second video image delayed by the frame memory on the monitor,
wherein when switching display of the monitor from the first video image to the second video image, the processor displays the first video image delayed by the frame memory on the monitor and then displays the second video image delayed by the frame memory on the monitor without displaying the dummy image on the monitor, and
wherein when switching display of the monitor from the second video image to the first video image, the processor displays the second video image delayed by the frame memory on the monitor and then displays the first video image delayed by the frame memory on the monitor without displaying the dummy image on the monitor.

According to this aspect, the frame memory is used for the first and second video images, but the frame memory is not used for the third video image; thus, seamless switching between the first and second video images and shortening of the delay for the third video image can be realized. In addition, since seamless switching between the first and second video images and shortening of the delay for the third video image are realized, multiple types of video images with different standards can be displayed.

### Item 2

The in-vehicle device according to Item 1, further including:
a first receiver that receives a display instruction for the first video image or the third video image from the user; and
a second receiver that receives a vehicle signal indicating a predetermined traveling state of the vehicle,
wherein when the first receiver receives the instruction, the generator outputs the first or third video image according to the instruction to the processor, and the processor displays the first or third video image according to the instruction on the monitor, and
wherein when the second receiver receives the vehicle signal, the processor displays the second video image on the monitor.

In this case, since switching between the display of the first video image and the display of the third video image is made based on the display instruction for the first or third video image received from the user and switching whether to display the second video image is made based on a vehicle signal, the display of multiple types of video images can be switched.

### Item 3

The in-vehicle device according to Item 2, wherein the predetermined traveling state of the vehicle is a reversing state of the vehicle.

In this case, the second video image can be displayed when the vehicle is in a reversing state.

### Item 4

The in-vehicle device according to any one of Items 1 through 3,
wherein, for the third video image, delay time from when an instruction for the third video image is received until when the third video image according to the instruction is displayed on the monitor is specified to be shorter than a first threshold value,
wherein, for the first video image, delay time from when an instruction for the first video image is received until when the first video image according to the instruction is displayed on the monitor is specified to be shorter than a second threshold value, or there is no requirement for the delay time from when an instruction for the first video image is received until when the first video image according to the instruction is displayed on the monitor, and
wherein the second threshold value is larger than the first threshold value.

Described above is an explanation on the present disclosure based on the embodiment. The embodiment is intended to be illustrative only, and it will be understood by those skilled in the art that various modifications to constituting elements and processes of the embodiment could be developed and that such modifications are also within the scope of the present disclosure.

While various embodiments have been described herein above, it is to be appreciated that various changes in form and detail may be made without departing from the spirit and scope of the invention(s) presently or hereafter claimed.

### CROSS-REFERENCE TO RELATED APPLICATION

This application is based upon and claims the benefit of priority from the prior Japanese Patent Application No. 2024-196656, filed on Nov. 11, 2024, the entire contents of which are incorporated herein by reference.

What is claimed is:

1. An in-vehicle device that is mountable in a vehicle, comprising:
a generator that generates a first video image; and
a processor that receives the first video image from the generator and displays the delayed first video image on a monitor after delaying the first video image by a frame memory,
wherein the processor receives the second video image from an imaging device outside the in-vehicle device and displays the second video image on the monitor after delaying the second video image by the frame memory,
wherein the generator receives a third video image from a communication device outside the in-vehicle device,
wherein the processor receives the third video image from the generator and displays the third video image on the monitor without delaying the third video image by the frame memory,
wherein when switching display of the monitor from the first or second video image to the third video image, the processor displays the first or second video image delayed by the frame memory on the monitor, then displays a dummy image on the monitor, and then displays the third video image not delayed by the frame memory on the monitor,
wherein when switching display of the monitor from the third video image to the first or second video image, the processor displays the third video image not delayed by the frame memory on the monitor, then displays the dummy image on the monitor, and then displays the first or second video image delayed by the frame memory on the monitor,
wherein when switching display of the monitor from the first video image to the second video image, the processor displays the first video image delayed by the frame memory on the monitor and then displays the second video image delayed by the frame memory on the monitor without displaying the dummy image on the monitor, and
wherein when switching display of the monitor from the second video image to the first video image, the processor displays the second video image delayed by the frame memory on the monitor and then displays the first video image delayed by the frame memory on the monitor without displaying the dummy image on the monitor.

2. The in-vehicle device according to claim 1, further comprising:
a first receiver that receives a display instruction for the first video image or the third video image from the user; and
a second receiver that receives a vehicle signal indicating a predetermined traveling state of the vehicle,
wherein when the first receiver receives the instruction, the generator outputs the first or third video image according to the instruction to the processor, and the processor displays the first or third video image according to the instruction on the monitor, and
wherein when the second receiver receives the vehicle signal, the processor displays the second video image on the monitor.

3. The in-vehicle device according to claim 2, wherein the predetermined traveling state of the vehicle is a reversing state of the vehicle.

4. The in-vehicle device according to claim 1,
wherein, for the third video image, delay time from when an instruction for the third video image is received until when the third video image according to the instruction is displayed on the monitor is specified to be shorter than a first threshold value,
wherein, for the first video image, delay time from when an instruction for the first video image is received until when the first video image according to the instruction is displayed on the monitor is specified to be shorter than a second threshold value, or there is no requirement for the delay time from when an instruction for the first video image is received until when the first video image according to the instruction is displayed on the monitor, and
wherein the second threshold value is larger than the first threshold value.

5. The in-vehicle device according to claim 2,
wherein, for the third video image, delay time from when an instruction for the third video image is received until when the third video image according to the instruction is displayed on the monitor is specified to be shorter than a first threshold value,
wherein, for the first video image, delay time from when an instruction for the first video image is received until when the first video image according to the instruction is displayed on the monitor is specified to be shorter than a second threshold value, or there is no requirement for the delay time from when an instruction for the first video image is received until when the first video image according to the instruction is displayed on the monitor, and
wherein the second threshold value is larger than the first threshold value.

6. The in-vehicle device according to claim 3,
wherein, for the third video image, delay time from when an instruction for the third video image is received until when the third video image according to the instruction is displayed on the monitor is specified to be shorter than a first threshold value,
wherein, for the first video image, delay time from when an instruction for the first video image is received until when the first video image according to the instruction is displayed on the monitor is specified to be shorter than a second threshold value, or there is no requirement for the delay time from when an instruction for the first video image is received until when the first video image according to the instruction is displayed on the monitor, and
wherein the second threshold value is larger than the first threshold value.
